(19) United States
(12) Patent Application Publication
(10) Pub. No.: US 2025/0343494 A1
(43) Pub. Date: Nov. 6, 2025

(54) SYSTEM AND METHOD OF SENSING SHAFT TORQUE

(71) Applicant: Saudi Arabian Oil Company, Dhahran (SA)

(72) Inventors: Sakethraman Mahalingam, Bridge of Don (GB); Christopher Wrighton, Rothienorman (GB)

(21) Appl. No.: 18/653,260

(22) Filed: May 2, 2024

(51) Int. Cl. H02P 23/14; E21B 43/12; H02K 3/52; H02K 5/132; H02K 21/16

(52) U.S. Cl. CPC H02P 23/14; H02K 3/522; H02K 5/132; H02K 21/16; E21B 43/128; H02K 2203/09; H02K 2213/12

(57) ABSTRACT

The present disclosure relates to methods and systems for determining the torque applied to a long shaft of a motor. A three-phase motor has a shaft, a main rotor-stator assembly and two sense stator-rotor assemblies. A control circuit applies three phase power to cables connected to the assemblies. At a measurement circuit, time-varying voltages on the cables are measured, which include the voltage induced due to the two sense rotor-stator assemblies. The sense assemblies differ from the main motor assembly to induce additional, small voltages into the electrical circuit. A transformation is applied to these signals to determine the main frequencies, amplitudes, and phases of the different signals. Using the phase differences among the voltages induced by the first and second sense rotor-stator assemblies and the main rotor-stator assembly, the torque on the shaft may be determined.

### TECHNICAL FIELD

The present disclosure relates to an electric submersible pump (ESP), and more particularly, to an ESP with a permanent magnet motor.

### BACKGROUND

A permanent magnet motor of an ESP is a synchronous motor and has embedded magnets in a rotor. The speed at which the rotor turns is in lockstep with a rotational speed of a magnetic field created by a stator. Sensing rotor position in a permanent magnet motor is important to achieve closed-loop control of the motor and achieve higher power density and efficiency. The diameter of the ESP shaft is much smaller (order of a few inches) compared to its length (order of a few dozen feet). Under such circumstances the torsional stiffness of the shaft of the motor is low and will easily twist during normal operation of the ESP.

### SUMMARY

The present disclosure relates to a motor for an electric submersible pump that induces a twist on the motor shaft, which can be used to determine torque. By accurately measuring torque, the motor efficiency, lifespan, and reliability can be determined.

An electric submersible pump motor is described. The pump motor includes a shaft, a main rotor-stator assembly coupled to the shaft, a first rotor-stator assembly coupled to the shaft; and a second rotor-stator assembly coupled to the shaft. The main rotor-stator assembly is positioned between the first rotor-stator assembly and the second rotor-stator assembly.

The main rotor-stator assembly may be a three-phase motor. The pump motor includes a first cable, a second cable, and a third cable. The three cables are coupled to a main stator of the main rotor-stator assembly, to a first stator of the first rotor-stator assembly, and to a second stator of the second rotor-stator assembly. The first stator, the main stator, and the second stator are electrically connected in series.

The pump motor may include a circuit coupled to the first cable, the second cable, and the third cable. The circuit applies a first AC signal to the first cable, a second AC signal to the second cable, and a third AC signal to the third cable. Each of the three AC signals are 120° shifted in phase from the other AC signals. The circuit also receives a first detected signal on the first cable, a second detected signal on the second cable, and a third detected signal on the third cable. The circuit also performs a transformation on the first detected signal, the second detected signal, and the third detected signal to generate a first transformed signal, a second transformed signal, and a third transformed signal. The circuit also determines, from the first, second, and third transformed signals, a first phase for the first transformed signal, a second phase for the second transformed signal, and a third phase of the third transformed signal. The circuit calculates a torque on the shaft based on a difference between two of the first phase, the second phase, and the third phase.

The main rotor-stator assembly may include a main number of poles. The first rotor-stator assembly may include a first number of poles, and the second rotor-stator assembly may include a second number of poles. Each pole of the main number of poles comprises a main winding number of windings. Each pole of the first number of poles comprises a first winding number of windings, and each pole of the second number of poles comprises a second winding number of windings. The main winding number, the first winding number, and the second winding number may be different from each other. The main number, the first number, and the second number may be different from each other. The first number of poles may be twice the main number of poles, and the second number of poles may be three times the main number of poles.

A bus-bar ring below the second rotor-stator assembly may electrically connect the first cable, the second cable, and the third cable. The first rotor-stator assembly and the second rotor-stator assembly are aligned along an axis of rotation of the shaft.

A method for calculating torque for a pump motor is described. The method for calculating torque includes applying a drive signal to the pump motor. The pump motor includes a shaft, a main rotor-stator pair, a first rotor-stator pair, and a second rotor-stator pair. Each of the rotor-stator pairs may include a stator and a rotor (a main stator and a main rotor, a first stator and a first rotor, and a second stator and a second rotor). The three rotor-stator pairs are coupled to the shaft. The main rotor-stator pair is disposed between the first rotor-stator pair and the second rotor-stator pair. The method further includes measuring a resultant signal received from the pump motor. A transform is applied to the resultant signal to determine a transformed signal/A twist on the shaft is determined based on the transformed signal, and a torque on the shaft is determined based on the twist on the shaft.

Determining the twist may include determining an angular difference of the first rotor relative to the second rotor. Determining the torque may include calculating the torque using the angular difference and a torsional stiffness of the shaft. Applying the transform may include converting the resultant signal from a time domain to a frequency domain.

The main rotor-stator pair can be a three-phase motor. The drive signal includes a first drive signal, a second drive signal, and a third drive signal. Each of the three drive signals is 120° out of phase with the other two drive signals. Applying the drive signal to the pump motor includes applying the first drive signal, the second drive signal, and the third drive signal to the main stator, the first stator, and the second stator. The resultant signal can include a first resultant signal, a second resultant signal, and a third resultant signal. Applying the transform to the resultant signal can include applying the transform to the first resultant signal, to the second resultant signal, and to the third resultant signal to produce a first transformed signal, a second transformed signal, and a third transformed signal. Determining the twist can include determining from the first, second, and third transformed signals, a first phase difference, a second phase difference, and a third phase difference and can further include using at least one of the first, second, and third phase differences. Determining the torque can be based on at least one of a length of the shaft, a diameter of the shaft, and a material property of the shaft.

Systems and methods described in the present disclosure can include one or more of the following advantages.

In accordance with certain methods of the present disclosure, the torque of an ESP motor may be measured directly. By calculating torque directly, the efficiency of the motor can be determined. Based on the calculated efficiency, the motor may be controlled more precisely to achieve better power, efficiency, and/or long-term reliability. This calculation is performed without the need for any additional wires connecting the motor to the surface and uses only the wires used to drive the motor.

Typically, measuring the large twist of the shaft is essential to know the rotor position accurately. Further, the measurement of this twist can provide us the actual torque of an ESP motor and would help us control the permanent magnet motor more accurately. Currently, the torque is only estimated by using the speed of the motor and an approximation of motor power.

The methods and systems described in this disclosure, however, are not limited to permanent magnet motors and are also applicable to other types of electric motors such as inductive motors, brushless motors, reluctance motors, and the like.

As used herein, the terms “top,” “bottom,” “upper,” “lower,” “above,” and “below” are used to provide a relative relationship between structures. The use of these terms does not indicate or require that a particular structure must be located at a particular location in the apparatus.

Some examples may be described using the expression “coupled” and “connected” along with their derivatives. For example, some arrangements may be described using the term “coupled” to indicate that two or more elements are in direct physical or electrical contact. The term “coupled,” however, may also mean that two or more elements are not in direct contact with each other, yet still co-operate or interact with each other. The examples described herein are not limited in this context.

Other features and advantages of the present disclosure will be apparent from the following detailed description, figures, and claims.

### BRIEF DESCRIPTION OF THE DRAWINGS

FIG. 1 is a diagram of a well completion system in an oil well including an electrical submersible pump (ESP) motor in accordance with the teachings of the present disclosure.

FIG. 2 is a cross-sectional view of an ESP motor assembly of FIG. 1 with sensing arrays in accordance with the teachings of the present disclosure.

FIG. 3 is a cross-sectional view of the motor assembly taken at Section 3-3′ of FIG. 2.

FIG. 4A is a circuit diagram of the motor assembly of FIG. 2.

FIG. 4B illustrates details of the control and measurement circuit of FIG. 4A.

FIG. 4C illustrates details of the busbar ring of FIG. 4A.

FIG. 5 is an example plot of a set of driving voltages applied to the motor assembly of FIG. 2.

FIG. 6 is an example plot of a measured set of voltages of the motor assembly of FIG. 2.

FIG. 7 is an example plot of calculated amplitudes from a transform of voltage signals from the motor assembly of FIG. 2.

FIG. 8 is an example plot of calculated phases from a transform of voltage signals from the motor assembly of FIG. 2.

FIG. 9 is a schematic drawing of a control system that can be used to perform operations in accordance with the present disclosure.

### DETAILED DESCRIPTION

The present disclosure relates to a system and method for measuring a shaft torque in a downhole permanent magnet motor to control an electric submersible pump (ESP). The torque in the shaft of a motor is a direct measure of the brake horsepower of the motor and helps measure the true efficiency of the motor. The methods and systems described herein may also draw on high-speed data communications transfer capability of the high-speed downhole sensor gauge (“speed gauge”) attached to the ESP, which ghosts data reliably over the motor three-phase power cables even during ground fault conditions. The speed gauge may allow electric motors that require precise rotor position feedback (e.g., switch reluctance motors and permanent magnet motors), to be considered for extreme step-out applications (e.g., shaft length greater than 3000 meters).

This disclosure describes a method of measuring the angular position of the shaft of a motor at two locations and inferring the torque on the shaft of the permanent magnet motor. This torque measurement is accomplished by adding two sensor rotor-stator sections at either end of the shaft and applying some analysis (e.g., a Fourier transform) to the resultant voltages.

The “sense rotor-stator assemblies” or “sense-motors” may use the existing wires that provide power to the motor (also called the “main motor”). These additional sense-motors communicate the rotational position of the shaft at two locations along the length of the shaft by inducing two small voltage signals at different frequencies than the frequency of the main motor. The additional sense rotor/stator assemblies are built in a similar fashion to the main motor but with some differences. No additional sensing wires are required.

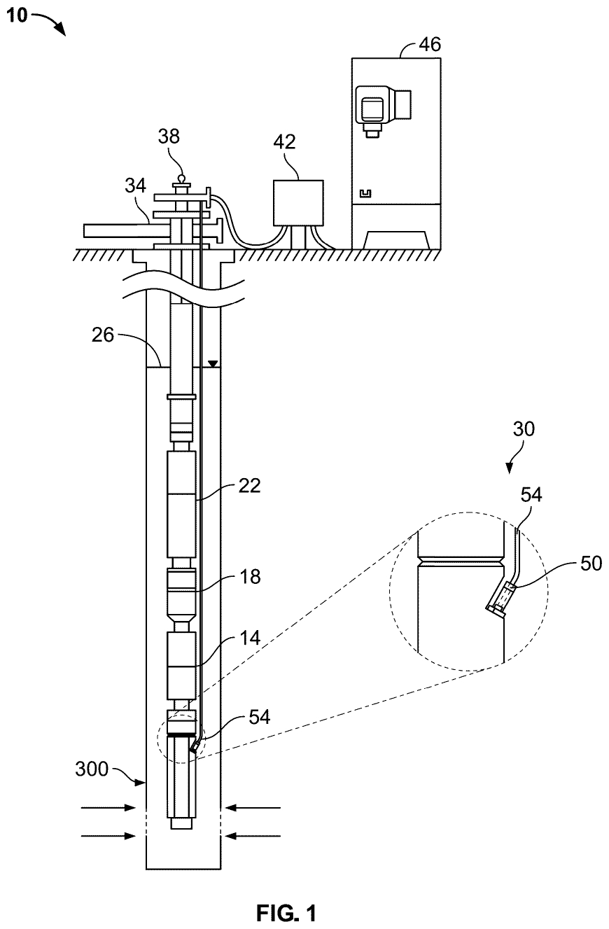

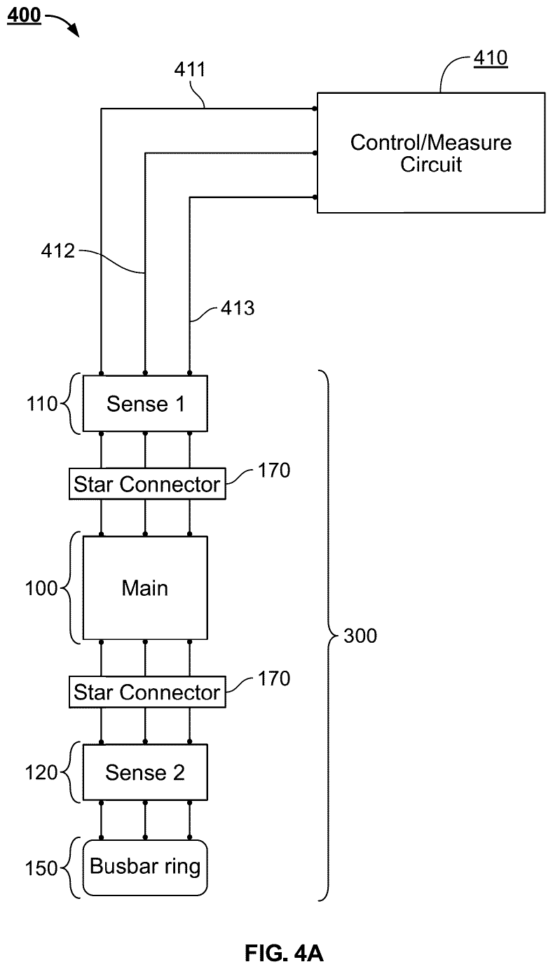

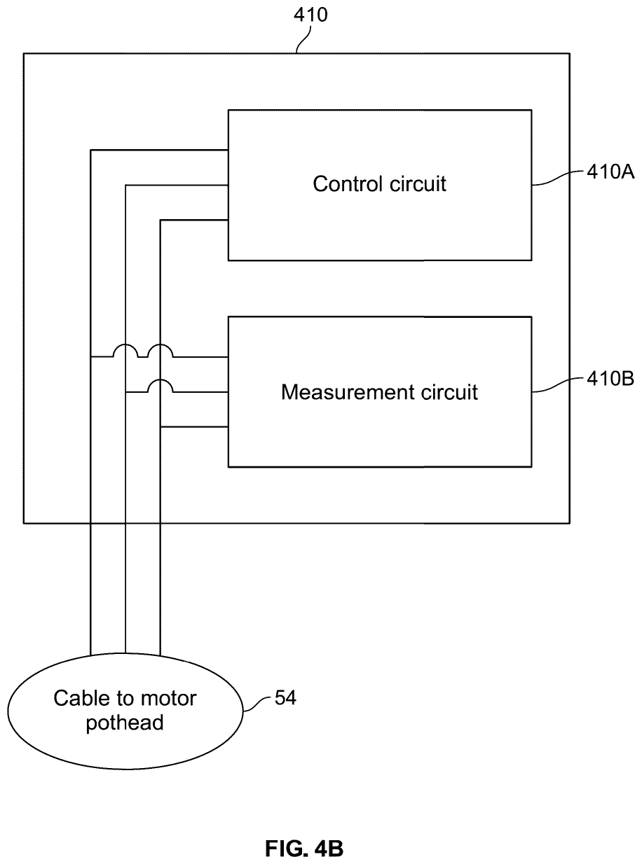

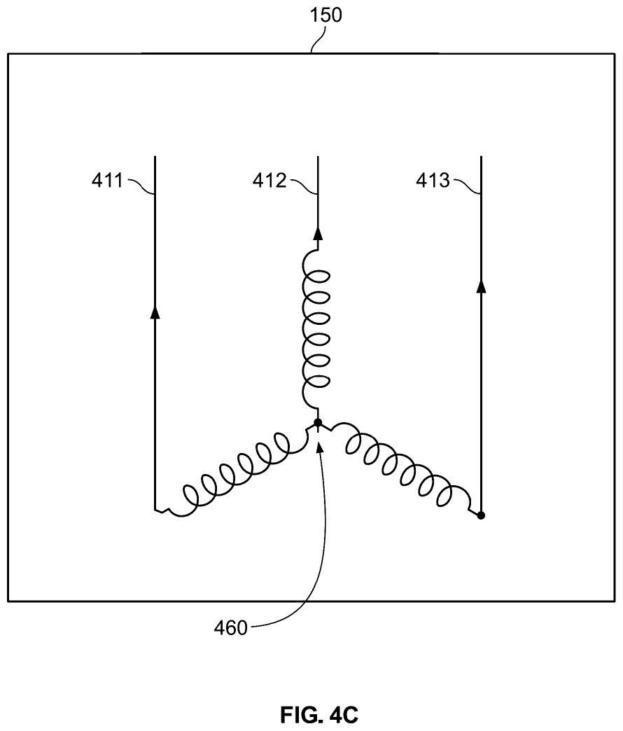

FIG. 1 illustrates a well completion system 10 with an electrical submersible pump motor assembly 300 of the present disclosure. The system 10 includes a well bore through which production tubing is fitted. Although not to scale, FIG. 1 shows, at the deepest part of the hole, the motor assembly 300. Above the motor assembly 300, the system 10 includes, in this example, a protector 14, an intake or gas separator 18, and a pump 22 that are disposed underneath a fluid level 26 of the system 10. At the surface 30, there is a flowline 34, a wellhead 38, a junction box 42, and a switchboard 46. The latter two items form part of the electrical circuit described in more detail below and with reference to FIG. 4. A connector 50 connects the cables 54 from the switchboard 46 to the motor assembly 300. Such connectors are known in the art such as a motor pothead.

The well completion system 10, in this example, includes a switchboard or control system 46 that can communicate through signals (e.g., wired or wirelessly) to one or more components of the system 10. For example, control system and/or control circuit 46, 410 can be communicably coupled to the motor assembly 300, protector 14, intake or gas separator 18, pump 22, wellhead 38, and/or junction box 42 In some aspects, control system and/or control circuit 46, 410 is a micro-processor based control system (or controller) that includes, e.g., hardware processor(s), memory module(s), and instructions executable as software code to cause the processor(s) to perform operations to control one or more components of the drilling system 10. However, the control system and/or control circuit 46, 410 can also be realized as a mechanical, electro-mechanical, hydraulic, pneumatic, or other form of a control system or controller without departing from the scope of this disclosure.

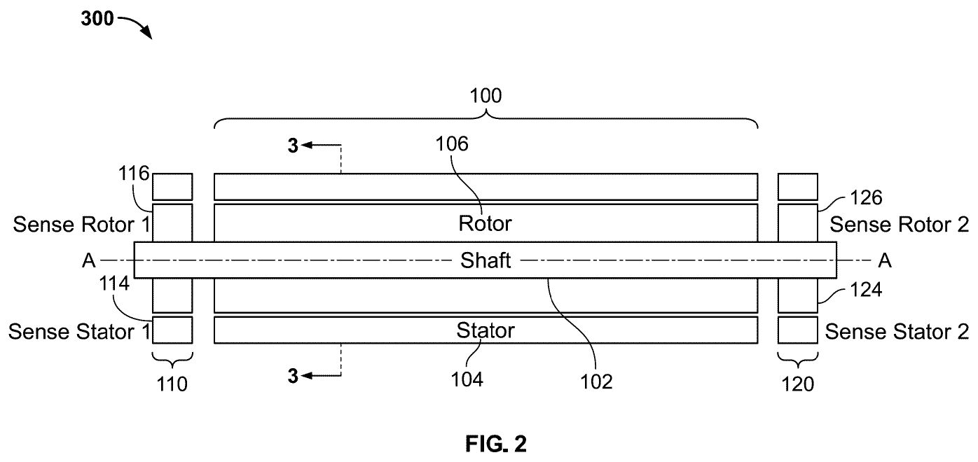

In FIG. 2, the motor assembly 300 includes a main motor assembly 100 (such as the ESP motor of FIG. 1), a first sense-motor assembly 110, and a second sense-motor assembly 120. The main motor assembly 100 includes a main stator 104, a main rotor 106, and a shaft 102. In this example, the shaft 102 of the motor assembly 300 extends beyond both ends of the main rotor 106 and the main stator 104, and the first sense assembly 110 and the second sense assembly 120 are coupled to the shaft 102. In other examples, the first sense-motor assembly 110 and the second sense-motor assembly 120 have their own shafts which are coupled to the shaft 102 of the main motor assembly 110. This disclosure refers to only the shaft 102 without loss of generality. The first sense-motor assembly 110 includes a first sense stator 114 and a first sense rotor 116. The first sense rotor 116 is coupled to the shaft 102 and rotates as the shaft 102 rotates. The first sense stator 114 is fixed relative to the rotation of the shaft 102. The second sense-motor assembly 120 includes a second sense stator 124 and a second sense rotor 126. The second sense rotor 126 is coupled to the shaft 102 and rotates as the shaft 102 rotates. The second sense stator 124 is fixed relative to the rotation of the shaft 102. In the illustrated example, the main motor assembly 100, the first sense assembly 110, and the second sense assembly 120 are aligned along a longitudinal axis A-A′ of the shaft 102.

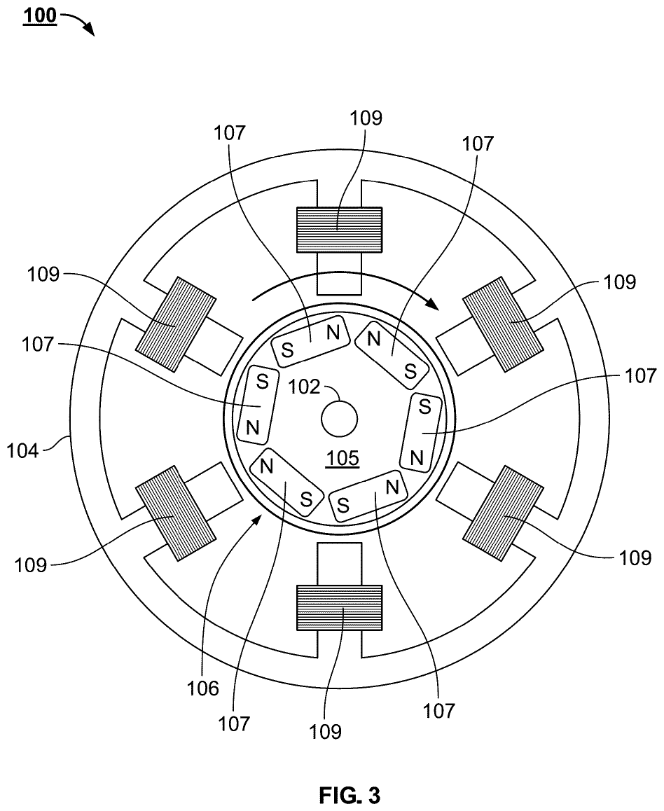

In FIGS. 2 and 3, the motor assembly 100 has a cylindrical shaft 102 to which the rotor 106 is attached. The rotor 106 and the shaft 102 are mounted within a stator 104. The rotor 106 includes a body 105 and multiple magnets 107.

In the illustrated example of FIG. 3, six permanent magnets 107 are embedded inside the body 105 of the rotor 106 (interior permanent magnet motor). In some motors, other approaches are used to incorporate the magnets in the rotor (e.g., surface mounted permanent magnet motor with the magnets attached to an outer surface of the body of the rotor). The magnets 107 are fixed in place relative to the shaft 102 and the rotors 106.

The rotors 106, 116, 126 have permanent magnets 107. The permanent magnets may be made of one or more of a variety of materials including, for example, AINiCo, neodymium, samarium-cobalt, and others.

The stators 104, 114, 124 have multiple slots receiving windings 109. When an electric current is flowing through windings 109, the windings 109 produce a magnetic field that pushes the permanent magnets 107 of the rotor or rotors 106 to rotate and thereby rotate the shaft 102 of the motor assembly 300. The stators 104 may include helical (or other) windings around a center point to create a uniform rotating magnetic field of the desired form. The stators 104 of FIG. 3 are only an example and other types of stators 104 may also be used.

While the example main motor assembly 100 of FIG. 3 includes six permanent magnets 107 mounted within the body of the rotor 106 and the stator 104 includes six windings 109, some motors have other configurations. In other examples, the magnets 107 may be different in number than the windings 109, may be placed in different locations, and may take different shapes, as decided by the system designer. Also, the magnets of the sense assemblies 110, 120 may be different than the magnets of the main motor assembly 100 in material, number, shape, location, or any combination of these.

The sense-motor assemblies 110, 120 may be built separately from the main motor assembly 100 and may be coupled to the main motor assembly 100 in series. Specifically, the sense-motor assemblies 110, 120 are electrically coupled to the main motor assembly 100 using “star-connectors” marked 170 in FIG. 4A. The rotors 116, 126 of the sense assemblies 110, 120 are connected (e.g., mechanically connected) to the shaft 102 of the main motor assembly 100. Returning briefly to FIG. 1, the example connector system 30 engages the electric cable 54 with a submersible component known in the art. Three terminals on the motor pothead 50 connect to the power cable 54 coming from surface. Other examples of integrating electrical cables and sense assemblies may be used instead.

Referring now to FIGS. 4A, 4B, and 4C, an example electrical circuit 400 is operatively coupled to the motor assembly 300. The circuit 400 includes the motor assembly 300, a control and measurement circuit 410, a first cable 411, a second cable 412, and a third cable 413. The control and measurement circuit 410 may be located in the switchboard 46 or may be located separately from the switchboard 46. The control and measurement circuit 410 may communicate with the VSD and the speed gauge, as necessary. The control portion 410A of the control and measurement circuit 410 produces drive voltages Vₐ, V_{b}, and V_{c}. The measurement portion 410B of the control and measurement circuit measures the voltage on the three cables 411, 412, and 413 as a function of time. The control circuit 410 is connected to motor assembly 300 by the cables 411, 412, and 413, combined in the power cable 54. Other motors may use more or fewer cables, but in the examples presented here, the motor is a three-phase motor coupled to three cables.

The control circuit 410A is configured to produce time-varying currents and voltages to rotate the shaft 102 of the motor assembly 300. For three-phase motors, these time-varying currents are typically at a frequency of 50 Hz or 60 Hz corresponding to the local power grid's main frequency. The control circuit 410A can include a variable frequency drive (e.g., a VSD) or other electronics configured to control the components of the motor assembly 300. In operation, the control circuit 410A applies three drive voltages Vₐ, V_{b}, and Ve to the cables 411, 412, and 413, respectively. These cables 411, 412, and 413 are bundled together in the power cable 54. The three cables 411, 412, and 413 connect to the first sense stator 114. From the first sense stator 114 the three cables 411, 412, and 413 connect to the main stator 104 through a “star-connector” 170. From the main motor stator 104, the three cables 411, 412, and 413 connect to the second sense stator 116 through another “star-connector” 170. From the second sense stator 116, the three cables 411, 412, and 413 connect to the busbar ring 150 for termination. In the example shown in FIG. 4C the three cables 411, 412, and 413 are terminated in the busbar 150 in a wye configuration including the neutral point 460. In other embodiments other termination configurations may also be used (e.g., delta configuration). The drive voltages Vₐ, V_{b}, and V_{c} applied to the cables 411, 412, and 413 by the control circuit 410A cause a current to flow through each of the cables 411, 412, and 413. The flowing electrical current passing through the main motor stator 104 causes a rotating magnetic field which causes the shaft 102 to rotate. The electrical current also flows through the sense sections 110, 120 of the motor assembly 300. A motion of the first sense rotor 116 relative to the first sense stator 114 induces a voltage (a back electromotive force) in the first sense stator 114, which causes an electrical current to move to counteract the drive voltages Vₐ, V_{b}, and V_{c} applied to the cables 411, 412, and 413 by the control circuit 410A. The motion of the second sense rotor 126 relative to the second sense stator 124 likewise induces a voltage and current flow in the second sense stator 126 to counteract the drive voltages Vₐ, V_{b}, and V_{c}. The sum of these induced voltages with the drive voltages can be sensed by the measurement circuit 410B. The measured voltages are called the voltage signals V₁, V₂, and V₃ shown in FIG. 4B. The control circuit 410A applies the drive voltages Vₐ, V_{b}, and V_{c} to the three cables 411, 412, and 413. The measurement circuit 410B measures the voltages V₁, V₂, and V₃ on the three cables 411, 412, and 413 which include the voltage induced by the first sense assembly 110 and the voltage induced by the second sense assembly 120 on each of the three cables 411, 412, and 413.

The first sense-motor assembly 110 has a different interaction between the first sense stator 114 and the first sense rotor 116 than an interaction between the main stator 104 and the main rotor 106. The second sense-motor assembly 120 also has a different interaction than the interaction between the first sense stator 114 and the first sense rotor 116 as well as the interaction between the main stator 104 and the main rotor 106. The sense assemblies 110, 120 have selected stators 114, 124 and rotors 116, 126 such that the voltages produced by their interactions are small relative to the drive voltages Vₐ, V_{b}, and V_{c} involved in driving the main motor assembly 100 to rotate the shaft 102 and so that the frequencies of the resultant voltages V₁, V₂, and V₃ are different than those from the main motor assembly 100 and also different from each other.

The resulting voltages V₁, V₂, and V₃ combine the drive voltages Vₐ, V_{b}, and V_{c} and the induced voltages from the first sense-motor assembly 110 and the induced voltages from the second sense-motor assembly 120. By performing a transformation on these resulting voltages, it is possible to detect a difference in angular position between the first sense rotor 116 and the second sense rotor 126. By measuring a phase difference between the voltage signal induced by first sense-motor assembly 110 and the voltage signal induced by second sense-motor assembly 120, a twist in the shaft 102 may be calculated. The twist in the shaft 102 can then be used to calculate torque on the shaft 102.

For example, there may be a phase shift of 10 degrees between the 10 V, 100 Hz signal of the first sense rotor-stator assembly 110 and the 10 V, 150 Hz signal of the second sense rotor-stator 120. This means the shaft 102 is twisted by 10 degrees from the location of the first sense-motor assembly 110 to the location of the second sense-motor assembly 120. The first sense motor assembly 110 is ahead by 10 degrees in spinning compared to the second sense motor assembly pair 120 due to the finite stiffness of the shaft 102.

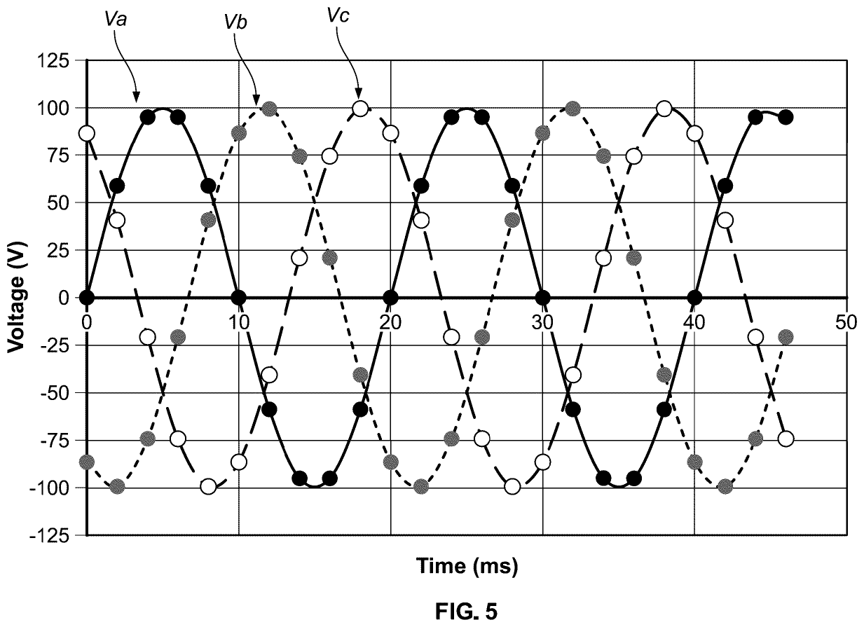

FIG. 5 illustrates an example plot of the drive voltages Vₐ, V_{b}, and V_{c}, being cycled at 50 Hz (period of 20 ms) with a peak voltage of 100 V. These voltages induce an electrical current to flow through the main stators 104 which rotate the shaft 102. The amplitudes of the drive voltages for an ESP motor application may be as low as 100 V and may be as high as 6000 V. The induced voltages from the sense assemblies 110, 120 are likely to be between 10 V to 100 V, or at most 10% of the peak amplitude of the drive voltage, and likely much less than that percentage. The three drive voltages are of the same amplitude and frequency but are different in phase by 120°. The resultant voltages V₁, V₂, and V₃ are the sum of the drive voltages Vₐ, V_{b}, and V_{c} applied to the respective cables 411, 412, 413 plus the voltage induced by the first sense-motor assembly 110 and the voltage induced by the second sense-motor assembly 120. Since the largest component in amplitude of the resultant voltages V₁, V₂, and V₃ are the drive voltages Vₐ, V_{b}, and V_{c}, and the induced voltages from the sense assemblies 110, 120 are selected to be small relative to the drive voltages Vₐ, V_{b}, and V_{c}, it is expected that the major frequency component of each of the resultant voltages V₁, V₂, and V₃ will be a main drive frequency.

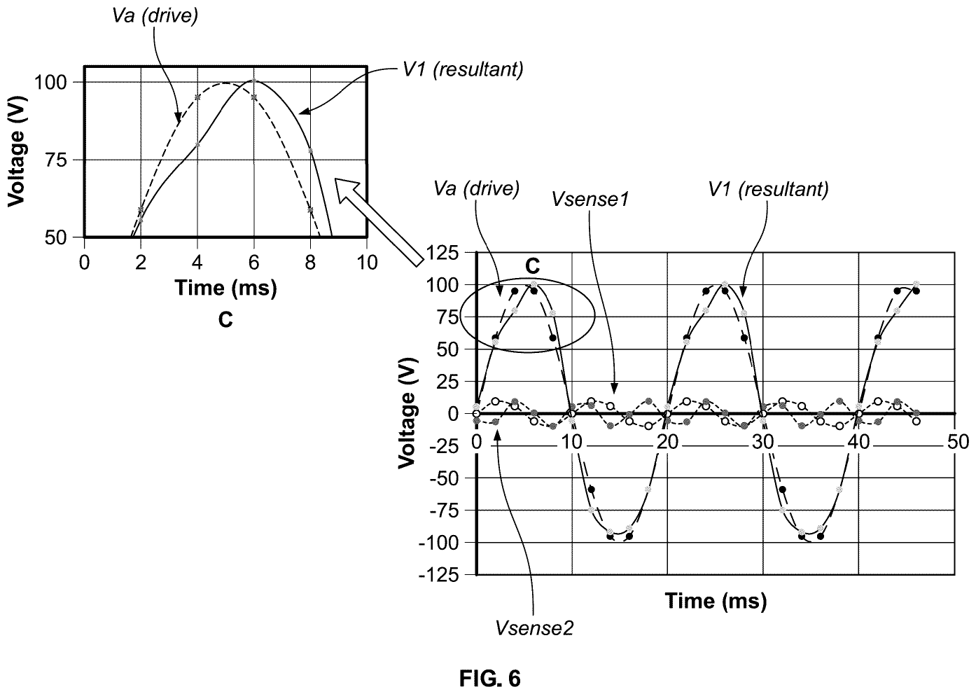

FIG. 6 illustrates a plot of the resultant voltage V₁ for the first component to illustrate the concept. In practice all components are measured, the transform applied to them, and the analysis performed on the transformed signals. The drive voltage Vₐ, the resultant voltage V₁, a voltage induced by the first sense assembly Vₛₑₙₛₑ₁, and a voltage induced by the second sense assembly Vₛₑₙₛₑ₂ are all plotted as a function of time. The induced sense voltages Vₛₑₙₛₑ₁ and Vₛₑₙₛₑ₂ have much smaller amplitudes than amplitudes of the drive voltage Vₐ and the resultant voltage V₁. In an example, the system may be designed so that the induced sense voltages may be limited to 10% of the peak drive voltage amplitude. The frequency the first sense voltage Vₛₑₙₛₑ₁ in this example is 100 Hz or twice the 50 Hz frequency of the drive voltage. The frequency of the second sense voltage Vₛₑₙₛₑ₂ in this example is 150 Hz or three times the 50 Hz frequency of the drive voltage. The smaller sense voltages modify the drive voltage to yield the resultant voltage V₁. Because the change is relatively small, an expanded section C is shown in the upper left of FIG. 6 to make clear of the difference between the resultant voltage V₁ and the drive voltage Vₐ.

Analyzing time-varying signals is well-known to engineers and mathematicians and in general involves transforming the signal from, for example, a time domain to, for example, a frequency domain. There are numerous such transforms including, but not limited to, Fourier transform, Laplace transform, cepstral analysis (the inverse Fourier transform of the logarithm of the signal), Z transform, and the like. In the analysis given below, the Fourier transform (or Fourier analysis) will be used, but other transforms or analytic methods may be applied to the resultant voltage signals.

Fourier analysis of the resultant voltages on each of the cables 411, 412, and 413 yields a decomposition of the signal into its different frequency components. For the simple case shown in FIG. 6, the first resultant voltage V₁ can be decomposed into three main components:

$${V}_{1} = {A}_{1} sin ( {ω}_{1} t + {ϕ}_{1} ) + {A}_{2} sin ( {ω}_{2} t + {ϕ}_{2} ) + {A}_{3} sin ( {ω}_{3} t + {ϕ}_{3} )$$

Where ϕᵢ is the phase angle, ωᵢ is the angular frequency, and Aᵢ is the voltage amplitude of the respective component.

The phase difference between first sense rotor 116 and second sense rotor 126 is equal to the change in their respective phase angles, or Δϕ=ϕ₃−ϕ₂.

Analogous equations can be written for the other two resultant voltages V₂ and V₃.

In the example illustrated in FIG. 6, the motor stator 104 has two poles, the first sense stator 114 has four poles, the second sense stator 124 has six poles, and a drive frequency (e.g., 50 Hz) is applied. The main motor assembly 100 causes the shaft 102 to rotate at approximately 3000 rpm in this example. When rotating at this rotational speed, the signal caused by the first sense assembly 110 will have a frequency of twice the drive frequency (e.g., 100 Hz) and the second sense assembly 120 will have a frequency of three times the drive frequency (e.g., 150 Hz) based on the ratio of the number of poles of the stators (e.g., main stator 104, first stator 114, second stator 124) in each of the three sections (e.g., main motor assembly 100, first sense assembly 110, and second sense assembly 120) of the motor assembly 300.

In this particular example, the resultant voltages can be simplified to the equation:

$${V}_{1} = {A}_{1} sin ( {ω}_{0} t + {ϕ}_{1} ) + {A}_{2} sin ( 2 {ω}_{0} t + {ϕ}_{2} ) + {A}_{3} sin ( 3 {ω}_{0} t + {ϕ}_{3} )$$

Where ω₀ is the frequency of the main motor assembly 100 (e.g., 50 Hz), ω₁=2ω₀ (e.g., 100 Hz) is the frequency of the first sense assembly 110, and ω₂=3ω₀ is the frequency (e.g., 150 Hz) of the second sense assembly 120.

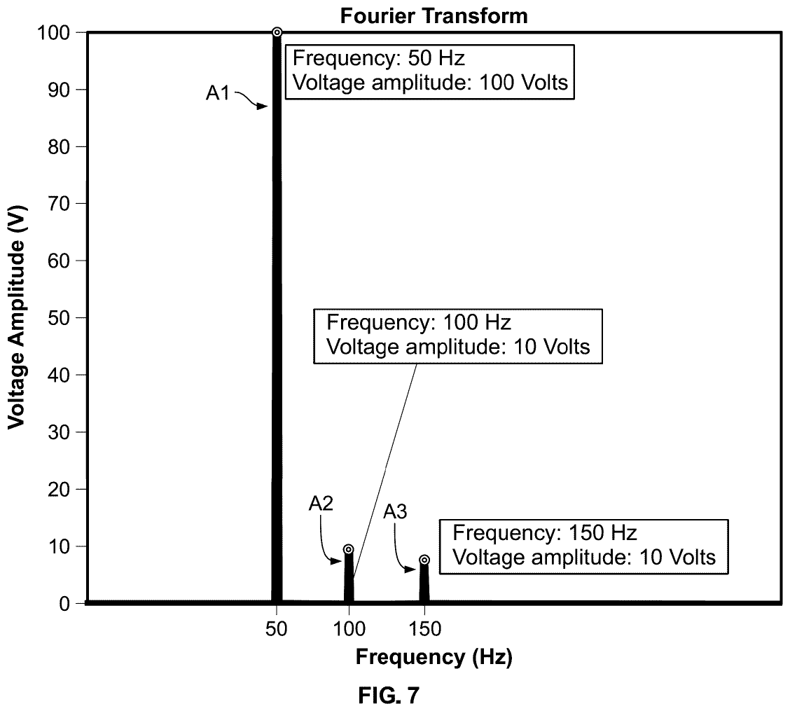

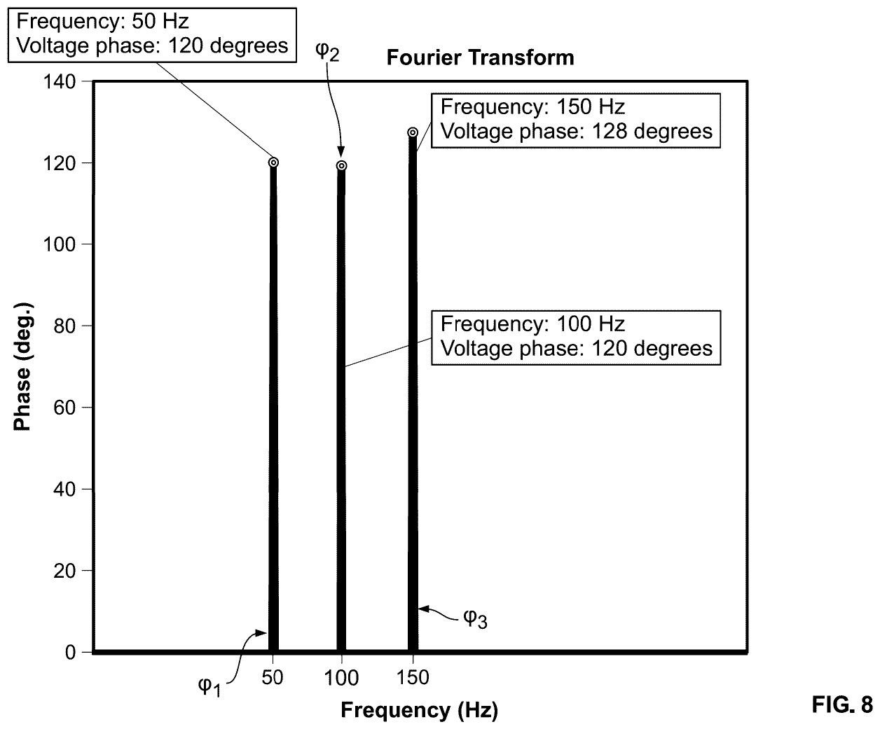

FIG. 7 and FIG. 8 illustrate plots of a Fourier analysis of a single resultant voltage V₁ for simplicity, rather than for all three resultant voltages. In practice it is possible to apply the transform to each of the three resultant voltages and obtain three measurements of phase shift. The drive voltage for FIGS. 7 and 8 are at 50 Hz and 100 V amplitude, as before; however, the first sense assembly 110, in this example, was designed to have a signal with a frequency of 100 Hz and an amplitude of 10 V when the drive frequency is 50 Hz. Analogously, the second sense assembly 120, in this example, was designed to produce a signal with a frequency of 150 Hz and an amplitude of 8 V when the drive frequency is 50 Hz. These frequencies demonstrate an easily implemented option, but other frequencies may be selected as well. These frequencies are used as examples only. In some instance frequencies can be selected to avoid the potential complications of higher order harmonics of the drive frequency from influencing the results, but other frequencies may result depending upon the design of the sense assemblies 110, 120 and the drive frequency of the main motor assembly 100. Transformations other than the Fourier transformation might be applied to avoid those situations in which higher order harmonics of the main drive signal might mix easily and obscure the induced voltage signal from the resultant voltages.

FIG. 7 illustrates the voltage amplitudes of the three main Fourier components of the breakdown of the resultant voltage V₁ as a function of frequency. In this example, the main component A1 has an amplitude of 100 V and occurs at 50 Hz. Thus, the resultant voltage V₁ is dominated by the 50 Hz, 100 V drive voltage. The second Fourier component A2 has an amplitude of 10 V at 100 Hz and the third Fourier component A3 has an amplitude of 8 V at 150 Hz.

FIG. 8 illustrates the phase of the three Fourier components for the first resultant voltage V₁ as a function of frequency. The first Fourier component has a frequency of 50 Hz and a phase of 120°. The second Fourier component has a frequency of 100 Hz and also a phase of 120°. The third Fourier component has a frequency of 150 Hz and a phase of 128°. The third component is thus 8° off from the second component and from the third component. Thus, the phase difference between the induced voltage from the first sense assembly 110 and the induced voltage from the second sense assembly 120 is, in this example, 8°, which means that the shaft 102 is twisted by this rotational amount between the first sense assembly 110 and the second sense assembly 120.

Once the phase difference between the signal voltages of the first sense assembly and the second sense assembly is known, it may be used in the formula below to calculate the torque or the twist on the shaft 102. The twist may be calculated by multiplying the phase difference by the shaft diameter. The torque may be calculated by taking into account the length of the shaft 102, the polar moment of inertia of the shaft 102 (dependent on the diameter of the shaft 102), and the shear modulus of the shaft 102. The relationship is generally expressed in the equation below:

$$τ = GJ \frac{Δ Φ}{L}$$

Where G=shear modulus of the material of the shaft, J=polar moment of inertia of the shaft (only a function of the diameter of the shaft), L=length of the shaft between sense stator 1 and sense stator 2, and ΔΦ=Phase shift between sense stator 1 and sense stator 2. The following are examples of variations of the motor assembly 300 of FIGS. 1-8.

### Example 1: Number of Sense Stator Poles Differ Amongst Sense Assemblies from Main Motor Assembly

When the control circuit 410A at the surface provides drive voltages at a certain frequency, the main motor assembly 100 responds accordingly. In the example given above, and re-stated here, the main motor assembly 100 can be a 2-pole motor and the VSD on the surface (which may be part of the control and measurement circuit 410) injects drive voltages at 50 Hz. The main motor assembly 100 then turns the shaft 102 at 3000 rpm. In the motor assembly 300, the shaft 102 also rotates at 3000 rpm or close to that, but the sense assemblies 110, 120 modify the resulting voltages. In this example, the first sense stator 114 has a 4-pole configuration, which means that it will try to spin the shaft 102 at 1500 rpm at that local section of the shaft 102 to which the first sense assembly 110 is coupled. Similarly, in this example, the second sense stator 124 is wound in a 6-pole configuration, so it will try to spin the shaft 102 at 1000 rpm at that section of the shaft 102 to which it is coupled. However, since the first sense assembly 110 and the second sense assembly 120 are much smaller and couple much less power to the shaft 102, their combined efforts do not significantly alter the rotation of the shaft 102 which will spin at close to 3000 rpm. The motor section 100 may be many times longer than the combined length of the sense assemblies 110, 120 and may couple many times the energy to the shaft 102 that the sense assemblies couple to the shaft 102. The first sense stator 114 and the first sense rotor 116 are designed such that the frequency of the resulting voltages the first sense assembly 110 induces are at a frequency different from the frequency at which the main motor 110 is rotating the shaft 102 and also different from that of the second sense assembly 120. Similarly, second sense stator 124 and the second sense rotor 126 are designed such that the frequency of the resulting voltage the second sense assembly 120 induces is at a frequency different from the frequency at which the main motor 110 is rotating the shaft 102 and different from the frequency of the first sense assembly 110.

In an example, the present system and method may use the three different sections (two sensor sections—the first sense assembly 110 and the second sense assembly 120—and one main section—the main motor assembly 100) and the induced voltage may have three frequency components. In an example, if the shaft 102 is spinning at close to 3000 rpm the spin may be induced by a 50 Hz signal corresponding to the main stator 104 interacting with the main rotor 106. If the first sense stator 114 is wound in a 4-pole configuration and the first sense rotor 116 is otherwise the same as the main rotor 106 then the first sense assembly 110 may have an induced frequency of 100 Hz (twice the frequency of the motor driving signals). If the second sense assembly 120 has a sense stator 124 wound in, say, a 6-pole configuration then the second sense assembly 120 may have an induced frequency of 150 Hz (three times the frequency of the motor driving signals). The signals may be analyzed by the control circuit 400 or by another circuit or at the variable frequency drive. This analysis may determine the angular position of the shaft by analyzing the 50 Hz signal but may also determine the angular positions of the first sense rotor 116 and the second sense rotor 126 relative to each other by analyzing the higher frequency signals, in this example the 100 Hz and the 150 Hz signals.

### Example 2: Sense Rotor-Stator Poles are Multiples of Main Rotor-Stator Poles

The combinations that are smallest absolute multiples of the motor frequency may be desirable-so 100 Hz (4 pole rotor-stator) and 200 Hz (8 pole rotor-stator) may be a desired combination for the case of two sense rotor-stator pairs. Multiples of the main motor frequency already may also be present in the signal as harmonics which might complicate the analysis.

The sense stators can include a number of poles arranged around the central axis of rotation of the shaft. By changing the number of poles in each of the sense stators to be different from the number of poles in the main stator, the voltage induced as the sense rotors rotate past the sense stators will be different.

### Example 3: Sense Stators Differently Shaped or Located

In another example the number of sense stators may be the same as the number of motor stators, but the sense stators may have different shapes than the motor stators. For example, the motor stators may be windings about a cylindrical core, but the first sense stator may be wound around a square-shaped core and the second sense stator may be wound around an oval shaped core. The first sense stators could be similar in shape to the motor stators but could be placed at an angle relative to the shaft which is different from the angle of the motor stators. The second sense stators could be placed at a second angle relative to the shaft different from the angle of the first stators and different from the angle of the motor stators. The first sense stators could be placed at a first radius out from the central axis of the shaft; the second sense stators could be placed at a second radius out from the central axis of the shaft; and the motor stators could be placed at a third radius out from the central axis of the shaft. These three radii may be different from each other.

### Example 4: Number of Sense Rotors Different from Number of Main Rotors

In another example, system may have a different number of magnets in the first sense rotor 116 from the number of magnets in the main rotor 106 and also a different number of magnets in the second sense rotor 127 from the number of magnets in the first sense rotor and also different from the number of magnets in the main rotor.

When discussing the number of magnets, especially the number of magnets in the main rotor 106, it is the number of magnets around the circumference and coupled to the shaft 102. Like any motor with a long shaft there may be many levels of stators and many rotor magnets along an axis parallel to the primary rotational axis of the shaft, but the relevant number being discussed in this example is the number in any plane perpendicular to the shaft's axis of rotation. Thus, if a plane perpendicular to the axis of rotation of the shaft has six magnets in the rotor 106 and six windings 109 for the stator 104 (as shown, for example, in FIG. 3) while the very long shaft has twenty such levels, the relevant number is six magnets and not the 120 magnets total of the entire apparatus.

### Example 5: Sense Rotors use Different Magnets from the Main Rotor

In an example of a permanent magnet motor the rotor 106 includes magnets 107 shaped and located to provide a desired magnetic field to interact with the magnetic field induced by electrical current flowing through the stators. The shape and composition of each of the magnets 107 in the rotor 106 determine the magnetic field created by the rotor. By varying the shape, the composition, the orientation, or the location of the magnets in the sense rotors 116, 126 compared to the main rotor 106 a different voltage can be induced in the sense stators than that induced in the main stators.

The main rotors of a motor may use rectangular-shaped magnets made using neodymium at certain locations and orientation relative to the center axis of rotation of the shaft. The first sense rotor 116 and the second sense rotor 126 may also use the same type of magnets of the same shape but placed at a different locations or different orientations.

In another example, the main rotor 106 uses rectangular-shaped magnets 107 which include a material using a certain percentage of neodymium. The first and second sense rotors 116, 126 may use instead a different material magnetic material with, say, a lesser percentage of neodymium, or a different magnetic material with different composition such as a material using samarium-cobalt, Alnico, or other materials. The first sense rotor 116 and the second sense rotor 126 would, of course, need to use slightly different magnetic material compositions from each other so that the induced voltage from each of the first sense stator 114 and the second sense stator 124 are different when detected. The magnetic field produced by the first sense stator 116 and by the second sense stator 126 need to be different not only from the magnetic field from the main rotor but also different from each other for the induced voltages and frequencies in the corresponding sense stators to be detected or differentiated from the voltage from the main rotor stator assembly. Thus, the sense rotors can use different types of magnetic material, differently shaped magnets, or magnets in different locations or different orientations to induce a different voltage in the corresponding sense stators from the voltage induced in the main stators.

With reference to FIGS. 1-8, an example operation of the motor assembly 300 can be performed to calculate torque on the motor shaft 102 and control the system 10 accordingly. One or more steps of the example operation can be performed by or with the control system and/or control circuit 46, 410 (e.g., with input from a human operator). For instance, the operation can include applying drive voltages, receiving electrical signals, performing transformations, determining twist, and calculating torque.

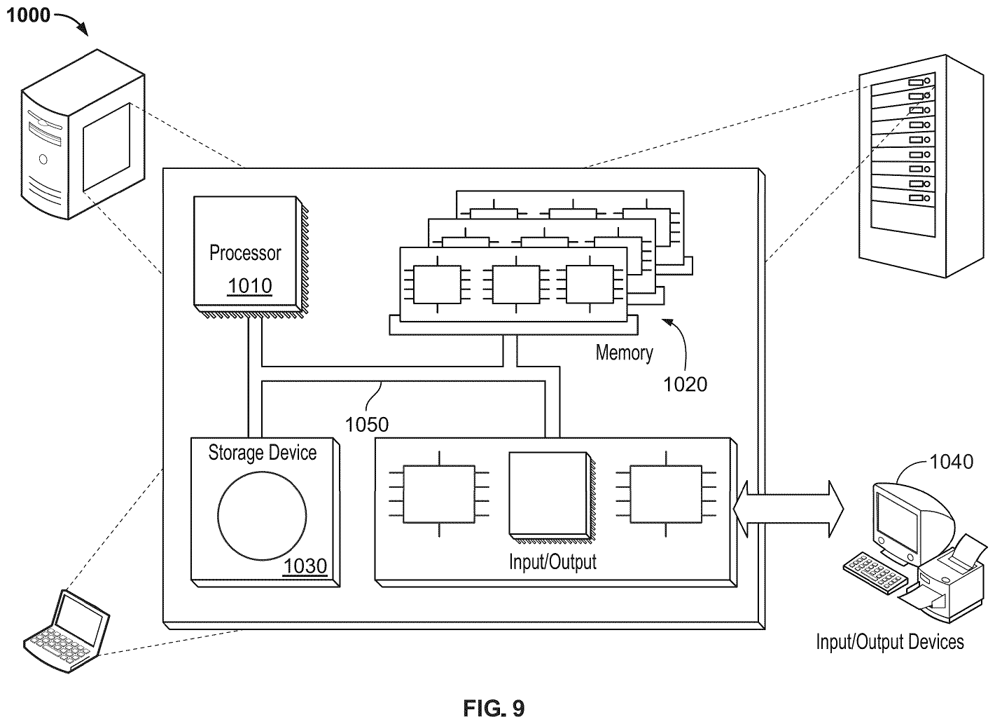

FIG. 9 shows a schematic drawing of a control system 1000 that can be used, e.g., as control system and/or control circuit 46, 410, to perform operations according to the present disclosure. Some or all of the example control system 1000 can be implemented as cloud-based system and/or service, alone or in combination with other portions of the example control system 1000 that can be implemented to execute. The controller 1000 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 1000 includes a processor 1010, a memory 1020, a storage device 1030, and an input/output device 1040. Each of the components 1010, 1020, 1030, and 1040 are interconnected using a system bus 1050. The processor 1010 is capable of processing instructions for execution within the controller 1000. The processor may be designed using any of a number of architectures. For example, the processor 1010 may be a CISC (Complex Instruction Set Computers) processor, a RISC (Reduced Instruction Set Computer) processor, or a MISC (Minimal Instruction Set Computer) processor.

In one implementation, the processor 1010 is a single-threaded processor. In another implementation, the processor 1010 is a multi-threaded processor. The processor 1010 is capable of processing instructions stored in the memory 1020 or on the storage device 1030 to display graphical information for a user interface on the input/output device 1040.

The memory 1020 stores information within the control system 1000. In one implementation, the memory 1020 is a computer-readable medium. In one implementation, the memory 1020 is a volatile memory unit. In another implementation, the memory 1020 is a non-volatile memory unit.

The storage device 1030 is capable of providing mass storage for the controller 1000. In one implementation, the storage device 1030 is a computer-readable medium. In various different implementations, the storage device 1030 may be a floppy disk device, a hard disk device, an optical disk device, a tape device, flash memory, a solid state device (SSD), or a combination thereof.

The input/output device 1040 provides input/output operations for the controller 1000. In one implementation, the input/output device 1040 includes a keyboard and/or pointing device. In another implementation, the input/output device 1040 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any disclosure or of what may be claimed, but rather as descriptions of features that may be specific to particular examples of particular disclosures. Certain features that are described in this specification in the context of separate examples can also be implemented in combination in a single example. Conversely, various features that are described in the context of a single example can also be implemented in multiple examples separately or in any suitable subcombination. Moreover, although features may be described herein as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the examples described herein should not be understood as requiring such separation in all examples, and it should be understood that the described program components and systems can generally be integrated together in a single product or packaged into multiple products.

Particular examples of the subject matter have been described. Other examples are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. An electric submersible pump motor, the pump motor comprising:
a shaft;
a main rotor-stator assembly coupled to the shaft;
a first rotor-stator assembly coupled to the shaft; and
a second rotor-stator assembly coupled to the shaft,
wherein the main rotor-stator assembly is positioned between the first rotor-stator assembly and the second rotor-stator assembly.

2. The pump motor of claim 1, wherein the main rotor-stator assembly is a three-phase motor.

3. The pump motor of claim 2, comprising a first cable, a second cable, and a third cable coupled to a main stator of the main rotor-stator assembly, to a first stator of the first rotor-stator assembly, and to a second stator of the second rotor-stator assembly.

4. The pump motor of claim 3, wherein the first stator, the main stator, and the second stator are electrically connected in series.

5. The pump motor of claim 3, further comprising a circuit coupled to the first cable, the second cable, and the third cable, wherein the circuit is configured to:
apply a first AC signal to the first cable, a second AC signal to the second cable, and a third AC signal to the third cable, wherein each of the first AC signal, the second AC signal, and the third AC signal is 120° shifted in phase from the other AC signals;
receive a first detected signal on the first cable, a second detected signal on the second cable, and a third detected signal on the third cable;
perform a transformation on the first detected signal, the second detected signal, and the third detected signal to generate a first transformed signal, a second transformed signal, and a third transformed signal;
determine, from the first, second, and third transformed signals, a first phase for the first transformed signal, a second phase for the second transformed signal, and a third phase of the third transformed signal; and
calculate a torque on the shaft based on a difference between two of the first phase, the second phase, and the third phase.

6. The pump motor of claim 2, wherein the main rotor-stator assembly comprises a main number of poles, the first rotor-stator assembly comprises a first number of poles, and the second rotor-stator assembly comprises a second number of poles.

7. The pump motor of claim 6, wherein each pole of the main number of poles comprises a main winding number of windings, each pole of the first number of poles comprises a first winding number of windings, and each pole of the second number of poles comprises a second winding number of windings; and
wherein the main winding number, the first winding number, and the second winding number are different from each other.

8. The pump motor of claim 6, wherein the main number, the first number, and the second number are different from each other.

9. The pump motor of claim 8, wherein the first number of poles is twice the main number of poles, and wherein the second number of poles is three times the main number of poles.

10. The pump motor of claim 1, further comprising a bus-bar ring below the second rotor-stator assembly wherein the bus-bar ring electrically connects the first cable, the second cable, and the third cable.

11. The pump motor of claim 10, wherein the first rotor-stator assembly and the second rotor-stator assembly are aligned along an axis of rotation of the shaft.

12. A method for calculating torque for a pump motor, the method comprising:
applying a drive signal to the pump motor, the pump motor comprising:
a shaft;
a main rotor-stator pair comprising a main stator;
a first rotor-stator pair comprising a first stator and a first rotor; and
a second rotor-stator pair comprising a second stator and a second rotor;
wherein the main rotor-stator pair, the first rotor-stator pair, and the second rotor-stator pair are coupled to the shaft, and wherein the main rotor-stator pair is disposed between the first rotor-stator pair and the second rotor-stator pair;
measuring a resultant signal received from the pump motor;
applying a transform to the resultant signal to determine a transformed signal;
determining a twist on the shaft based on the transformed signal; and
determining a torque on the shaft based on the twist on the shaft.

13. The method of claim 12, wherein determining the twist comprises determining an angular difference of the first rotor relative to the second rotor.

14. The method of claim 13, wherein determining the torque comprises calculating the torque using the angular difference and a torsional stiffness of the shaft.

15. The method of claim 12, wherein applying the transform comprises converting the resultant signal from a time domain to a frequency domain.

16. The method of claim 12, wherein
the main rotor-stator pair is a three-phase motor;
the drive signal comprises a first drive signal, a second drive signal, and a third drive signal, wherein each of the first, second, and third drive signals is 120° out of phase with the other two drive signals; and
wherein applying the drive signal comprises applying the first drive signal, the second drive signal, and the third drive signal to the main stator, the first stator, and the second stator.

17. The method of claim 16, wherein the resultant signal comprises a first resultant signal, a second resultant signal, and a third resultant signal; and
wherein applying the transform to the resultant signal comprises applying the transform to the first resultant signal, the second resultant signal, and the third resultant signal to produce a first transformed signal, a second transformed signal, and a third transformed signal.

18. The method of claim 17, wherein determining the twist comprises determining from the first, second, and third transformed signals, a first phase difference, a second phase difference, and a third phase difference.

19. The method of claim 18, wherein determining the twist comprises using at least one of the first, second, and third phase differences.

20. The method of claim 16, wherein determining the torque is based on at least one of a length of the shaft, a diameter of the shaft, and a material property of the shaft.
